(19) United States
(12) Patent Application Publication
(10) Pub. No.: US 2007/0283426 A1
(43) Pub. Date: Dec. 6, 2007

(54) Method for Assigning an Authentication Certificate and Infrastructure for Assigning Said Certificate

(75) Inventors: Loic Houssier, Alforville (FR); Laurent Frisch, Paris (FR); David Arditti, Clamart (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 11/660,543

(22) PCT Filed: Aug. 5, 2005
(86) PCT No.: PCT/FR05/02040

§ 371 Date: Feb. 20, 2007

(30) Foreign Application Priority Data
Aug. 19, 2004 (FR) 0408992

(51) Int. Cl. H04L 9/32

(52) U.S. Cl. 726/6

(57) ABSTRACT

This method provides for electronic certificate assignment in a certificate assignment infrastructure distributed in a network. The infrastructure includes at least one certificate server, an identity server and a registration server linked to the network. Prior to a certificate application request, information relating to the identity of a certificate applicant is stored in the identity server, the identity information being accessible by way of an identifier. In this method, an applicant requests a certificate from the registration server; the identifier is dispatched to the identity server; after verification of the identifier, the identity server dispatches the previously registered identity of the applicant, said identity being provided to the registration server; after receipt of the identity, the registration server dispatches a certificate request including the identity of the applicant to the certificate server, and the certificate server dispatches the certificate destined for the applicant.

The invention pertains to infrastructures for managing keys for open network computer systems. More particularly, the invention pertains to a certificate assignment method as well as to a system which makes it possible to assign a certificate according to the method.

In the present invention, what is called a certificate must be understood as the certificate making it possible to validate a cryptographic key used on an open computer network. By way of example, a standard commonly used on the Internet for public key, certificate and certificate revocation list management infrastructures is known by the name X.509 and more particularly X.509v3 defined in RFC3280 (Request For Comment No. 3280) published by the IETF (the Internet Engineering Task Force). The certificate is an object comprising, inter alia, a public key to be certified, the identity of its possessor, a period of validity, a list of the rights of use of the key and a cryptographic signature of these data carried out with the aid of the public key of a certification authority issuing the certificate.

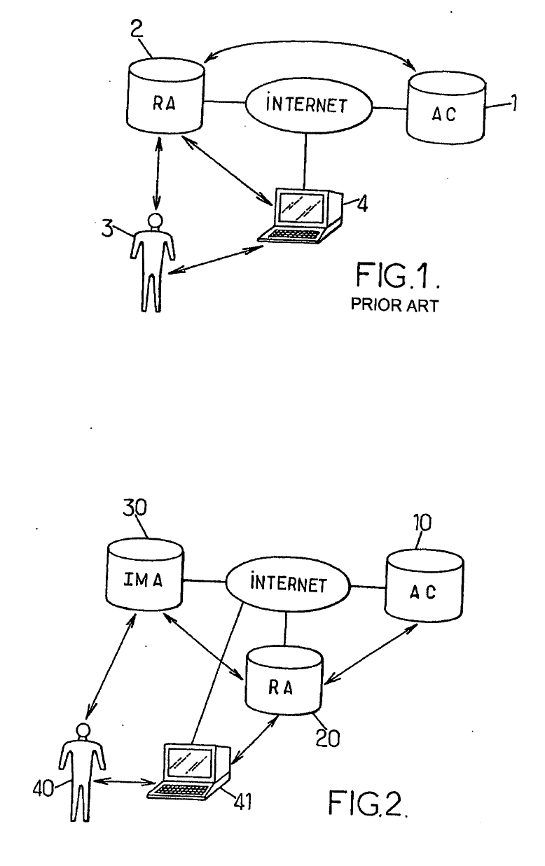

A platform for managing certificates is commonly called a public key infrastructure, hereafter PKI. The role of a PKI is not only to create the certificates but also to manage their validity, that is to say their revocation and their renewal. FIG. 1 shows an example of a PKI according to the state of the art. The PKI chiefly comprises a certification authority (AC) embodied by a certificate server 1, and a registration authority (RA) embodied by a registration server 2. The certificate server 1 and the registration server 2 are for example linked together via the Internet, and communicate in a secure manner.

The certification authority is a body recognized as being competent and trusted to deliver and manage certificates as well as to ensure their validity. During the granting of a certificate, the certification authority calculates a public key and a private key so as to assign it to an applicant. The private key is thereafter provided to the applicant together with the certificate so that the latter can use it as a message signature key or access key for accessing secure WEB services or for other applications requiring secure access. During use of the private key, the certification authority will be called upon to verify the validity of this key and of the various data relating to the certificate, in particular its validity and its activation or its revocation.

The registration authority serves to draw up a certificate request at the certification authority for a certificate applicant. The registration authority must draw up a complete certificate request in which various information will be dispatched as a function of the certificate applied for. For certificates requiring a high level of security, the registration authority is charged with verifying the information provided by the applicant relating to his identity and to verify whether the latter is authorized to request such a certificate comprising the attribute list requested in the certificate.

Currently, when an applicant 3 requests a certificate from the registration server 2 by way of a terminal 4 also connected to the Internet, the registration authority may ask him either to travel to verify certain information in person, or to dispatch, by conventional mail, items proving his identity. This relatively reliable procedure has however a few drawbacks:

the issuing of a certificate application request by the registration authority to the checking authority is subject to the verification of the identity of the person, this may necessitate a delay in the granting when the applicant must travel or dispatch supporting evidence to prove his identity;

an applicant desiring to obtain several certificates corresponding to different PKIs, must register with various registration authorities and systematically repeat the operations aimed at proving his identity although the latter has not changed;

the verification checks on the identity of the person applying for a certificate must necessarily be done by way of an operator and do not allow a registration authority to make do with a simple server centralizing the data.

The invention is aimed at obviating the drawbacks cited above. According to the invention, a pre-registration of the identity of the applicant is carried out by a third party entity so that the registration authority can obtain certified information on the identity of the applicant. Thus, when an applicant requests a certificate from the registration server, the registration server verifies information with an identity server previously advised on the identity of the applicant. By virtue of the use of an identifier making it possible to obtain identity information certified with an identity server, the registration server can perform the request more rapidly by going to verify the validity and possibly complete, at the identity server, the information requested on the identity and in a certified manner, for the obtaining of a new certificate. An applicant need only register just once with an identity management authority to produce his identity at a plurality of registration servers. Also, the registration authority no longer needs to systematically verify identity information verified once and for all by the identity management authority.

Thus, the invention is a method of electronic certificate assignment in a certificate assignment infrastructure distributed in a network, the infrastructure including at least one certificate server, an identity server and a registration server linked to the network. Prior to a certificate application request, information relating to the identity of a certificate applicant is stored in the identity server, the identity information being accessible by way of an identifier. An applicant requests a certificate from the registration server. The identifier is dispatched to the identity server. After verification of the identifier, the identity server dispatches the previously registered identity of the applicant, said identity being provided to the registration server. After receipt of the identity, the registration server dispatches a certificate request including the identity of the applicant to the certificate server. The certificate server dispatches the certificate destined for the applicant.

Preferably, the registration server asks the applicant for his identifier, so as to dispatch it to the identity server. After verification of the identifier, the identity server dispatches to the registration server the previously registered identity of the applicant at the registration server (20). The certificate server dispatches the certificate to the registration server. The registration server provides the certificate to the applicant.

According to various embodiments, the identifier can be an anonymous identifier. The identifier can itself be a certificate. The identifier can be accompanied by a verification means. The verification means can be provided by the applicant to the registration server which provides it to the identity server, and the identity server returns the identity to the registration server only if the verification means validates the identifier. The verification means can be a certificate verified by the registration server.

According to a variant, several identity servers are linked to the network, each server comprising complementary identity information registered prior to a certificate application request, the identity information being accessible by way of an identifier specific to each identity server. The registration server retrieves the identity information from the various identity servers so as to reconstitute a complete identity before dispatching it to the certificate server.

The invention is also a computer program product comprising instructions for implementing the method during execution by processing means implementing the method.

Also, the invention pertains to a computer readable recording medium, which comprises a computer program implementing the method when said program is executed by processing means implementing the method.

According to another aspect, the invention is an infrastructure for certificate assignment on a computer network. The infrastructure comprises at least an authentication certificate server linked to the network and able to provide an electronic certificate for an applicant, for a given duration and for a defined object, the certificate being delivered after the receipt of an identity of an applicant; an identity server linked to the network, the identity server containing information relating to the identity of a certificate applicant, the identity server being able to provide, after receipt of an identifier, the previously registered identity of the applicant; a registration server linked to the network and able to request the identity information relating to the applicant from the identity server, following an applicant's certificate request, then to dispatch a certificate request to the certificate server including the applicant's identity information.

Preferably, the identity server is able to verify the validity of the identifier so as to return the identity to the registration server only if the identifier is valid.

According to a variant, several identity servers are linked to the network, each server comprising complementary identity information registered prior to a certificate application request, the identity information being accessible by way of an identifier specific to each identity server. The registration server is able to retrieve the identity information from the various identity servers so as to reconstitute a complete identity before dispatching it to the certificate server.

The invention will be better understood and other features and advantages will appear on reading the description which will follow, the description referring to the appended figures among which:

FIG. 1 represents an exemplary public key management infrastructure according to the state of the art,

FIG. 2 represents a first embodiment of a public key management infrastructure according to the invention,

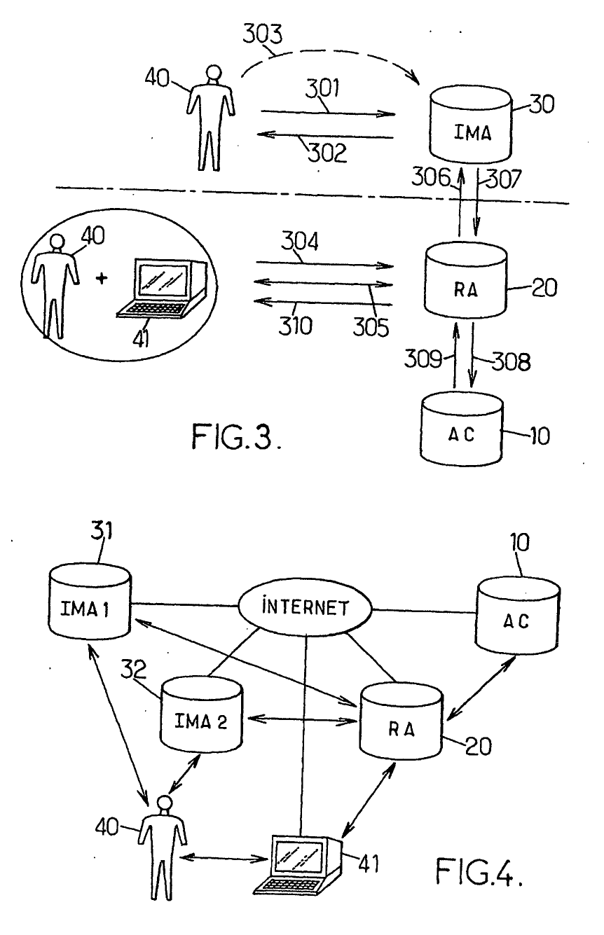

FIG. 3 diagrammatically represents the exchanges inside the infrastructure of FIG. 2 for requesting a certificate,

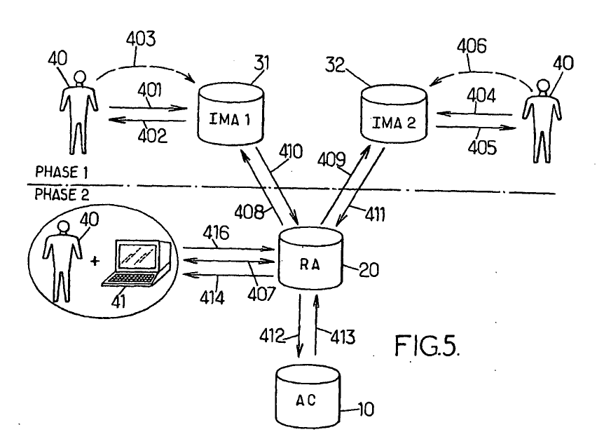

FIG. 4 represents a second embodiment of a public key management infrastructure according to the invention,

FIG. 5 represents in a diagrammatic manner the exchanges necessary for obtaining a certificate with the aid of the infrastructure of FIG. 4.

FIG. 2 represents a first embodiment of a public key management infrastructure according to the invention. This infrastructure comprises a certificate server 10, a registration server 20 and an identity server 30. The said servers 10, 20 and 30 are physically distinct and are linked together via the Internet and communicate with the aid of a secure link. The certificate server 10 embodies the certification authority. The certificate server 10, on receipt of a certificate application request issued in proper and due form by the registration server 20, is able to calculate a public key and a private key then to provide a certificate containing the public key as well as the other attributes of the certificate. The registration server 20 embodies the registration authority. The registration server 20 is able to receive registration application requests originating from a user 40, possibly by way of a terminal 41, itself linked to the Internet. The registration server 20 is able to fetch from the identity server 30 the information relating to the identity of the applicant 40. The identity server 30 embodies an identity management authority and contains information on the identity of a certificate applicant 40. The interaction between the identity server 30 and the applicant 40 can be effected by way of a terminal 40 via the Internet or in a direct manner, either physically, or by another communication means such as conventional correspondence with the applicant by mail.

Each server 10, 20 and 30 is furnished with a computer program for interacting with the other servers so as to carry out the method of obtaining a certificate which will be described subsequently. The program can be stored on a computer readable recording medium prior to implementation on said servers.

A certificate application according to the invention is carried out in two phases as shown in FIG. 3. During a first phase, the applicant registers his identity with the identity server 30. In the course of a first step 301, the applicant 40 provides the identity server with information relating to his identity, that is to say name, forename, and the like. In the course of this first step 301, the applicant 40 will provide the identity management authority with all the supporting evidence necessary to prove the veracity of the given information so as to register it in the identity server 30. From the moment at which a minimum of identity supporting evidence has been provided to the identity management authority, the identity is registered in the server 30 and the latter provides the applicant 40 with an anonymous identifier associated with the identity information in the course of a second step 302. The identifier makes it possible to access the identity information in the identity server. If the complete registration of the identity information could not be done in the course of step 301, the applicant can in the course of a third step 303, provide complementary supporting evidence to the identity management authority which will register in the identity server the complementary information after having verified it.

In FIGS. 2 and 3 is represented a single identity server 30, it should be noted that the identity management authority comprises, in addition to the identity server 30, means of interface with the applicant 40. These interface means are, for example a physical operator situated in an agency, either in proximity to the server, or a remote agency linked to said server via the Internet via a secure link. It should be noted that the applicant 40 can provide the information and evidence supporting his identity in one step 301 or in two steps 301 and 303. When the identity and the identity supporting evidence are provided in two or more steps, the applicant can converse with one or more agencies linked to said identity server 30.

Once the identity server 30 is correctly advised as to the identity, the applicant 40 will be able to apply for certificates from the public key management infrastructure by way of a terminal 41, the first phase is then terminated.

A second phase corresponding to the certificate request can then commence. In the course of a step 304, the applicant dispatches to the registration server 20 a certificate application request. During a step 305, the registration server will, inter alia, ask the applicant to provide evidence of his identity. In response to this identity request, the applicant merely dispatches his identifier to said registration server 20.

On receipt of the identifier, the registration server 20 will ask, in the course of a step 306, the identity server 30 to dispatch to it the certified information corresponding to said identifier. In the course of a step 307 and after having checked the validity of the identifier, the identity server 30 provides the registration server 20 with the information present in its database and which is associated with said identifier and relates to the identity of the applicant 40.

On receipt of the identity information, and in the course of a step 307, the registration server 20 dispatches a complete certificate application request to the certificate server 10. The certificate server 10 will then calculate a public key and a private key and draw up a corresponding certificate for the applicant 40. The certificate and the private key are thereafter transmitted in the course of a step 309 to the registration server 20. The registration server 20 provides the applicant with the certificate and the private key in the course of a step 310.

It should be noted that the information exchanged, on the one hand, between the terminal 41 and the registration server 20 and, on the other hand, between the three servers 10, 20 and 30 is done by way of the Internet with the aid of a secure protocol, for example the protocol known by the term HTTPS or HTTP (standing for HyperText Transfer Protocol) with SSL (standing for Secure Socket Layer).

The benefit of a public key management infrastructure such as this, together with the certificate assignment method, originates from the fact that the identity, once stored in the identity server 30, can be used by a plurality of registration server 20 and that this identity registration is done once only.

The identifier provided to the applicant 40 by the identity server 30 can be of various types. According to a first embodiment, the identifier can be a simple password making it possible to access the identity information contained in the server 30. The password is then provided in a secure manner to the registration server 20 which will thereafter provide it to the identity server 30. In response to said password, the identity server 30 will provide the identity information corresponding to the identifier.

According to a more secure variant, the identifier can itself be a certificate. Thus, the fields of a form provided to the applicant 40 by the registration server are filled in with information relating to the identity of the applicant. The fields are thereafter signed with the aid of the private key associated with the certificate of the identifier. The thus signed form is thereafter dispatched by the registration server 20 to the identity server 30. The identity server 30 verifies the signature of the form with the aid of its public key and if the latter is verified, it then provides the registration server 20 with the identity information of said form, certifying said information and possibly adding complementary identity information not present on the form.

The certificate can also be a nonpersonal or anonymous certificate contained in a chip card accompanied with its PIN code.

The identity information relating to a person can be relatively numerous. Name and forename were cited previously. To this basic identity information may be added other complementary identity information such as date and place of birth, nationality, sex, but also biometric information or information, for example relating to a bank account. It is not necessary for all this information to be provided for a given certificate application. Likewise, for confidentiality reasons, it may be preferred not to store in one single server all this information relating to the identity of a person. Also, storage of the entirety of the identity information relating to a person may require relatively significant means, hardly manageable by a single authority.

For this purpose, an infrastructure variant embodiment according to the invention is represented in FIG. 4. In this FIG. 4, the identity server 30 is replaced with two physically distinct identity servers 31 and 32 linked to the Internet. The identity servers 31 and 32 will comprise common and complementary identity information. By way of example, the identity server 31 will for example comprise the name and the forename of the person, accompanied by biometric information such as fingerprints or voice signature. And the identity server 32 will register in it more conventional information such as information regarding civil identity, name, forename, date of birth, place of birth, nationality, sex, social security number, bank account number, etc. Quite obviously, for the server 31, it is obligatory that the person travels for the measurement of the biometric information and that said person provides evidence of his identity with the aid of a legal identity item. For the identity server 32, all this information can be provided by post, with the aid of conventional identity supporting evidence.

Here again, a certificate application is made in two phases as shown in FIG. 5. In the course of the first phase, the applicant will advise the servers 31 and 32 in a mutually independent manner. Thus, in the course of a first step 401, the applicant 40 will provide the server 31 with first information relating to his identity, for example, biometric information. The applicant 40 will therefore travel to an agency which will first of all verify his identity by presenting an identity card and for example register these fingerprints or else register voice identification. Once this information has been registered in this biometric server, the server 31 will provide a first identifier in the course of step 402. If by chance, the applicant 40 desires to modify or register new biometric information, he can still do so in the course of a step 403 by simultaneously providing his identifier with the data of the additional information by also travelling to the identity management authority associated with the server 31.

Still in the course of the first phase, the applicant 40 will also do what is necessary to register his identity with the server 32. In the course of a step 404, he will provide information accompanied by papers as evidence of his identity, for example his identity card as well as all the papers making it possible to prove that his residence is indeed real, etc. The various information being verified by a person during registration in the server 32, a second identifier is provided to the applicant 40 in the course of step 405. Here again, if the applicant desires to register other information relating to his identity, for example his bank account or possibly his social security number, he can still in the course of a step 406 provide said information together with the necessary supporting evidence accompanied by his identifier.

Once the various information relating to his identity has been registered with the servers 31 and 32, the applicant 40 can then ask the registration server 20 to assign him a certificate by way of a terminal 41 connected to the Internet. The request is dispatched in the course of a step 416. In the course of a step 407, the registration server and the applicant will dialogue so as to fill in the forms requested by the registration server for a certificate application and to provide the registration server 20 with the first and second identifiers corresponding respectively to the servers 31 and 32. Once the registration server has retrieved the identifiers, it will simultaneously dispatch them to the identity servers 31 and 32 in the course of steps 408 and 409. Steps 408 and 409 are quasi simultaneous and there is no need for the registration server to wait for the response of the identity servers before dispatching the next identifier. In response to the identifier received in the course of step 408, the identity server 31 will verify this first identifier and dispatch the identity information certified in the course of a step 410. After having received the second identifier in the course of step 409, the identity server 32 will verify this identifier and provide in return the complementary identity information in the course of a step 411. Thereafter, the registration server will compile the various identity information received in a single form destined for the certificate server 10. The information originating from the server 31 and that originating from the server 32 is placed in a single form. In the course of a step 412, the registration server dispatches the duly completed request containing the applicant's identity information 40 to the certificate server 10. The latter in return calculates a public key and a secret key and draws up a certificate that it dispatches to the registration server in the course of a step 413. The certificate is thereafter delivered by the registration server to the applicant 40 in the course of a step 414.

It should be noted that the registration server may merely ask the identity server 31 or 32 for only a limited amount of information relating to identity with respect to the information contained in said servers. Specifically, the server 31 comprises biometric information, for example fingerprints and voice signature, while the application for identity information may concern only the voice signature, it is therefore not necessary to transfer information relating to fingerprints.

In the examples described, the applicant 40 provides the identifier to the registration server 20 which interrogates the identity server 30 to obtain the applicant's identity information. According to a variant, it is possible for the applicant 40 to interrogate the identity server 30 directly in order that the latter provide the identity information to the registration server 20. Also, it is possible for the identity to be provided to the applicant by the identity server 30 in the form of a certificate. The applicant can then produce the certificate to the registration server 20 which merely verifies the validity of the certificate with the identity server.

In the examples described, the certificate and the associated private key that are provided by the certificate server 10 to the applicant 40 pass via the registration server 20. It is entirely possible to deliver the certificate and the private key to the applicant 40 without going via the registration server 20.

1. A method of electronic certificate assignment in a certificate assignment infrastructure distributed in a network, the infrastructure including at least one certificate server, an identity server, and a registration server linked to the network, said method comprising:
prior to a certificate application request, information relating to the identity of a certificate applicant is stored in the identity server, the identity information being accessible by way of an identifier,
an applicant requests a certificate from the registration server,
the identifier is dispatched to the identity server,
after verification of the identifier, the identity server dispatches the previously registered identity of the applicant, said identity being provided to the registration server,
after receipt of the identity, the registration server dispatches a certificate request including the identity of the applicant to the certificate server, and
the certificate server dispatches the certificate destined for the applicant.

2. The method as claimed in claim 1, in which:
the registration server asks the applicant for his identifier, so as to dispatch it to the identity server, and
after verification of the identifier, the identity server dispatches to the registration server the previously registered identity of the applicant at the registration server.

3. The method as claimed in claim 1, in which:
the certificate server dispatches the certificate to the registration server, and
the registration server provides the certificate to the applicant.

4. The method as claimed in claim 1, in which the identifier is an anonymous identifier.

5. The method as claimed in claim 1, in which the identifier is accompanied by a verification means.

6. The method as claimed in claim 5, in which:
the verification means is provided by the applicant to the registration server which provides it to the identity server, and
the identity server returns the identity to the registration server only if the verification means validates the identifier.

7. The method as claimed in claim 5, in which the verification means is a certificate verified by the registration server.

8. The method as claimed in claim 1, in which several identity servers are linked to the network, each server comprising complementary identity information registered prior to a certificate application request, the identity information being accessible by way of an identifier specific to each identity server,
and in which the registration server retrieves the identity information from the various identity servers so as to reconstitute a complete identity before dispatching it to the certificate server.

9. The method as claimed in claim 1, in which the information exchanges between the applicant and the registration server are done by way of the network.

10. The method as claimed in claim 1, in which the identifier is itself a certificate.

11. (canceled)

12. (canceled)

13. An infrastructure for certificate assignment on a computer network, wherein the infrastructure comprises:
an authentication certificate server linked to the network and able to provide an electronic certificate for an applicant, for a given duration and for a defined object, the certificate being delivered after the receipt of an identity of an applicant;
an identity server linked to the network, the identity server containing information relating to the identity of a certificate applicant, the identity server being able to provide, after receipt of an identifier, the previously registered identity of the applicant; and
a registration server linked to the network and able to request the identity information relating to the applicant from the identity server, following a certificate request from an applicant, then to dispatch a certificate request to the certificate server including the applicant's identity information.

14. The infrastructure as claimed in claim 13, in which the identifier is an anonymous identifier.

15. The infrastructure as claimed in claim 13, in which the identity server is able to verify the validity of the identifier so as to return the identity to the registration server only if the identifier is valid.

16. The infrastructure as claimed in claim 13, in which several identity servers are linked to the network, each server comprising complementary identity information registered prior to a certificate application request, the identity information being accessible by way of an identifier specific to each identity server,
and in which the registration server is able to retrieve the identity information from the various identity servers so as to reconstitute a complete identity before dispatching it to the certificate server.

17. The infrastructure as claimed in claim 13, furthermore comprising an access terminal linked to the network, the access terminal being able to communicate with the registration server so as to serve as interface for the applicant.

18. The infrastructure as claimed in claim 13, in which the identifier is a certificate.

19. A computer readable medium comprising computer executable instructions for causing a computer to execute a method of electronic certificate assignment in a certificate assignment infrastructure distributed in a network, the infrastructure including at least one certificate server, an identity server and a registration server linked to the network, in which the method comprises:
prior to a certificate application request, information relating to the identity of a certificate applicant is stored in the identity server, the identity information being accessible by way of an identifier,
an applicant requests a certificate from the registration server,
the identifier is dispatched to the identity server,
after verification of the identifier, the identity server dispatches the previously registered identity of the applicant, said identity being provided to the registration server,
after receipt of the identity, the registration server dispatches a certificate request including the identity of the applicant to the certificate server, and
the certificate server dispatches the certificate destined for the applicant.

20. The computer readable medium as claimed in claim 19, in which:
the registration server asks the applicant for his identifier, so as to dispatch it to the identity server, and
after verification of the identifier, the identity server dispatches to the registration server the previously registered identity of the applicant at the registration server.

21. The computer readable medium as claimed in claim 19, in which:
the certificate server dispatches the certificate to the registration server, and
the registration server provides the certificate to the applicant.

22. The computer readable medium as claimed in claim 19, in which the identifier is an anonymous identifier.

23. The computer readable medium as claimed in claim 19, wherein method the identifier is accompanied by a verification means.

24. The computer readable medium as claimed in claim 23, in which the:
the verification means is provided by the applicant to the registration server which provides it to the identity server, and
the identity server returns the identity to the registration server only if the verification means validates the identifier.

25. The computer readable medium as claimed in claim 23, in which the verification means is a certificate verified by the registration server.

26. The computer readable medium as claimed in claim 19, in which several identity servers are linked to the network, each server comprising complementary identity information registered prior to a certificate application request, the identity information being accessible by way of an identifier specific to each identity server,
and in which the registration server retrieves the identity information from the various identity servers so as to reconstitute a complete identity before dispatching it to the certificate server.

27. The computer readable medium as claimed in claim 19, in which information exchanges between the applicant and the registration server are done by way of the network.
